(19) United States
(12) Patent Application Publication
(10) Pub. No.: US 2007/0078631 A1
(43) Pub. Date: Apr. 5, 2007

(54) Sample analyzer, processing computer for sample analysis, method of displaying operation screen of sample analyzer and computer program product for processing computer for sample analysis

(75) Inventors: Shunsuke Ariyoshi, Kakogawa-shi (JP); Toru Mizumoto, Kobe-shi (JP); Shoichiro Asada, Akashi-shi (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION

(21) Appl. No.: 11/527,563

(22) Filed: Sep. 27, 2006

(30) Foreign Application Priority Data
Sep. 27, 2005 (JP) 2005-280673

(51) Int. Cl. G06F 15/00

(52) U.S. Cl. 702/189

(57) ABSTRACT

A sample analyzer which performs analysis processing on a sample measurement result is provided, which displays a plurality of first icons to call up the display of a plurality of function screens provided in correspondence with a plurality of functions of the sample analyzer fixedly in part of the icon display area in the operation screen, changes, when the first icons are selected, the display of the function screen display area in the operation screen to the display of the function screens corresponding to the selected first icons and changes the display of some other parts of the icon display area in the operation screen to the display of the second icons which operate the function screens corresponding to the selected first icons.

### TECHNICAL FIELD

The present invention relates to a sample analyzer, processing computer for sample analysis, a method of displaying an operation screen of the sample analyzer and a computer program for the processing computer for sample analysis.

### BACKGROUND

Examples of a sample analyzer include a hemacytometer, blood coagulation analyzer, immunity analyzer, biochemical analyzer, particle analyzer and so on.

Here, as an example of the sample analyzer, Japanese Patent Laid-Open No. 2003-232797 discloses a living body sample analyzer for analyzing a sample of living body such as blood.

The display screen of this living body sample analyzer displays basic operation icons in a first display section (toolbar) on a display screen and displays function selection icons in a second display section (area below the toolbar) on the display screen.

The basic operation icons are icons that correspond to commands often used especially when operating the apparatus such as an icon for starting an analysis.

The first display section is a section dedicated to displaying basic operation icons, not overwritten by other window screens in principle and the basic operation icons displayed in the first display section are fixedly displayed on the screen.

The basic operation icons include some icons for displaying function selection icons in the second display section, and when one of these icons is selected, a function selection window is displayed in the second display section and the function selection icons are displayed in this function selection window.

In this way, the basic operation icons corresponding to commands which are used with a high frequency are fixedly displayed in the first display section, which allows these commands to be executed conveniently.

The sample analyzer such as a hemacytometer, blood coagulation analyzer, immunity analyzer, biochemical analyzer or particle analyzer has high functions and it includes therefore many screens. For example, there are screens such as an analysis result list display, analysis result detail display screen, quality control result display screen and measurement condition setting screen.

Since such a many screens are provided, the display section of the sample analyzer requires many icons to display these screens. Moreover, in addition to these icons, icons to operate the respective screens (for example, setting and inputting of a measurement condition, correction and deletion of an analysis result, validation of the analysis result and so on) are necessary.

Therefore, the sample analyzer as a whole requires quite many icons.

However, the living body sample analyzer described in Japanese Patent Laid-Open No. 2003-232797 displays the basic operation icons fixedly in the first display section (toolbar) and some of these basic operation icons include the icons to display function selection icons, and therefore there is not much space to arrange the icons to display screens (windows) which are important to the analyzer such as the analysis result screen and measurement condition setting screen.

Furthermore, the basic operation icons displayed in the first display section need not be operated depending on the display screen and unnecessary icons are displayed light-colored (in gray), i.e. non-highlighted display, in such a case so as not to accept operation. However, since such unnecessary icons are also fixedly displayed, the limited display spaces are wasted.

Therefore, there are cases where it is not possible to display icons corresponding to necessary commands in the first display section (toolbar) and executing such commands may take much trouble and time.

### SUMMARY

The first aspect of the present invention relates to a sample analyzer for analyzing a sample, comprising:

a display

first displaying means for displaying a screen on the display, the screen comprising an icon display area and a function screen area, the icon display area having a first area for displaying first and second function-select-icons and a second area for displaying at least one of screen-operate-icon;

second displaying means for displaying the first and second function-select-icons on first area and the screen-operate-icon on the second area;

an input device for receiving input to select at least one of the icons in the icon display area; and

third displaying means for displaying a first function screen on the function screen area and changing the screen-operate-icon which is displayed on the second area, when the input device receives input to select the first function-select-icon,

wherein the screen-operate-icon is assigned to operation of the first function screen.

The second aspect of the present invention relates to a sample analyzer for analyzing a sample, comprising:

a display;

first displaying means for displaying a screen on the display, the screen comprising an icon display area and a function screen area;

second displaying means for displaying a first, a second and a multi function icon on the icon display area, the first icon is assigned to a function of displaying a first operation screen, the second icon is assigned to a function of displaying a second operation screen, and the multi function icon is assigned to operation of the first and the second operation screen;

an input device for receiving input to select at least one of the first icon, the second icon, and the multi function icon; and

third displaying means for displaying the first operation screen on the function screen area when the input device receives input to select the first icon, and displaying the second operation screen on the function screen area when the input device receives input to select the first icon.

The third aspect of the present invention relates to a processing computer for a sample analysis, comprising:

a display

first displaying means for displaying a screen on the display, the screen comprising an icon display area and a function screen area, the icon display area having a first area for displaying first and second function-select-icons and a second area for displaying at least one of screen-operate-icon;

second displaying means for displaying the first and second function-select-icons on first area and the screen-operate-icon on the second area:

an input device for receiving input to select at least one of the icons in the icon display area; and

third displaying means for displaying a first function screen on the function screen area and changing the screen-operate-icon which is displayed on the second area, when the input device receives input to select the first function-select-icon,

wherein the screen-operate-icon is assigned to operation of the first function screen.

The fourth aspect of the present invention relates to a method of displaying operation screen for a sample analyzer, comprising:

displaying an operation screen comprising an icon display area and a function screen area, the icon display area having a first area for displaying first and second function-select-icons and a second area;

displaying, when designation of the first function-select-icon is received, a first function screen on the function screen area and a first screen-operate-icon on the second area; and

displaying, when designation of the second function-select-icon is received, a second function screen on the function screen area and a second screen-operate-icon on the second area.

The fifth aspect of the present invention relates to a computer program product for a processing computer for a sample analyzer, comprising:

a program code to display an operation screen comprising an icon display area and a function screen area, the icon display area having a first area for displaying first and second function-select-icons and a second area;

a program code to display, when designation of the first function-select-icon is received, a first function screen on the function screen area and a first screen-operate-icon on the second area; and

a program code to display, when designation of the second function-select-icon is received, a second function screen on the function screen area and a second screen-operate-icon on the second area.

### BRIEF DESCRIPTION OF THE DRAWINGS

FIG. 1 is a system configuration diagram of a multi-item automatic blood cell analyzer:

FIG. 2 is a block diagram of a measurement section;

FIG. 3 is a block diagram of a system control section;

FIG. 4 is a perspective view of a sample reck/sample container;

FIG. 5 is a functional block diagram of the system control section by a program;

FIG. 6 is a basic configuration diagram of an operation screen;

FIG. 7 is a display example of a menu screen;

FIG. 8 is a display example of a QC file screen:

FIG. 9 is a display example of a QC chart screen;

FIG. 10 is a display example of a “Register measurement” screen;

FIG. 11 is a display example of a sample explorer screen;

FIG. 12 is a display example of a data browser screen;

FIG. 13 is a display example of a reagent replacement history screen;

FIG. 14 is a display example of a toolbar;

FIG. 15 is a display example of the toolbar;

FIG. 16 is an example of a pop-up display;

FIG. 17 is a display example of the toolbar;

FIG. 18 is an arrangement example of the toolbar;

FIG. 19 is an arrangement example of the toolbar;

FIG. 20 is a display example of a measurement section help dialog;

FIG. 21 is a display example of a manual mode measurement dialog for a sample; and

FIG. 22 is a display example of the manual mode measurement dialog for a quality control substance.

### BEST MODE FOR CARRYING OUT THE INVENTION

Hereinafter, preferred embodiments of the present invention will be described based on the attached drawings.

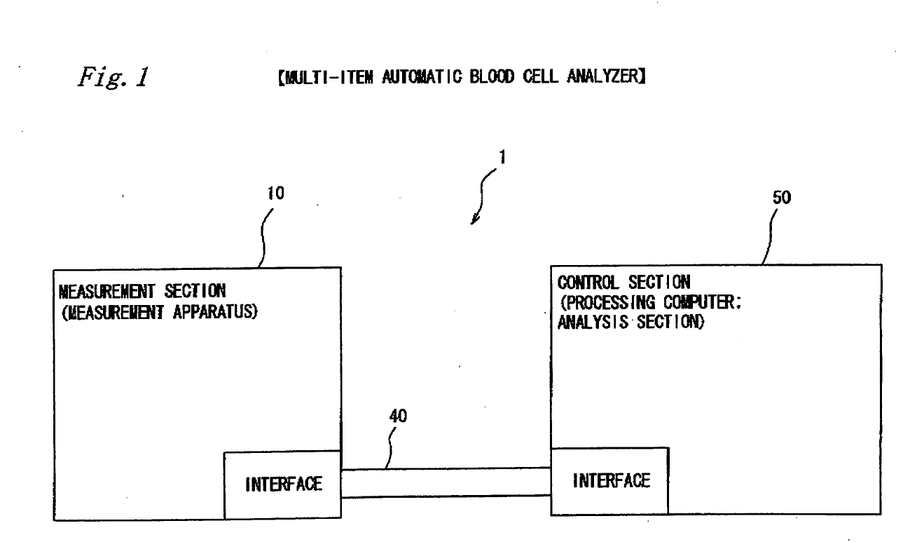

FIG. 1 shows a multi-item automatic blood cell analyzer as an example of the sample analyzer.

This multi-item automatic blood cell analyzer 1 measures blood which is a sample and analyzes the measurement result and is constructed of a measurement section 10 which actually measures blood cells in the blood and a system control section (processing computer; analysis section) 50 which controls the whole apparatus.

The measurement section 10 measures a blood cell counting (CBC) of the blood sample, white blood cell classifying (DIFF) and reticulated blood cell (RET) according to a flow site meter scheme using an electric resistance system and a semiconductor laser. The CBC item includes the number of red blood cells (RBC), the number of white blood cells (WBC), the number of platelets (PLT), amount of hemoglobin (HGB), hematocrit value (HCT) or the like.

Furthermore, the measurement section 10 and system control section 50 are mutually connected so as to be able to send data under a TCP/IP scheme which is a kind of so-called communication protocol through a communication line 40.

[Configuration of Measurement Section]

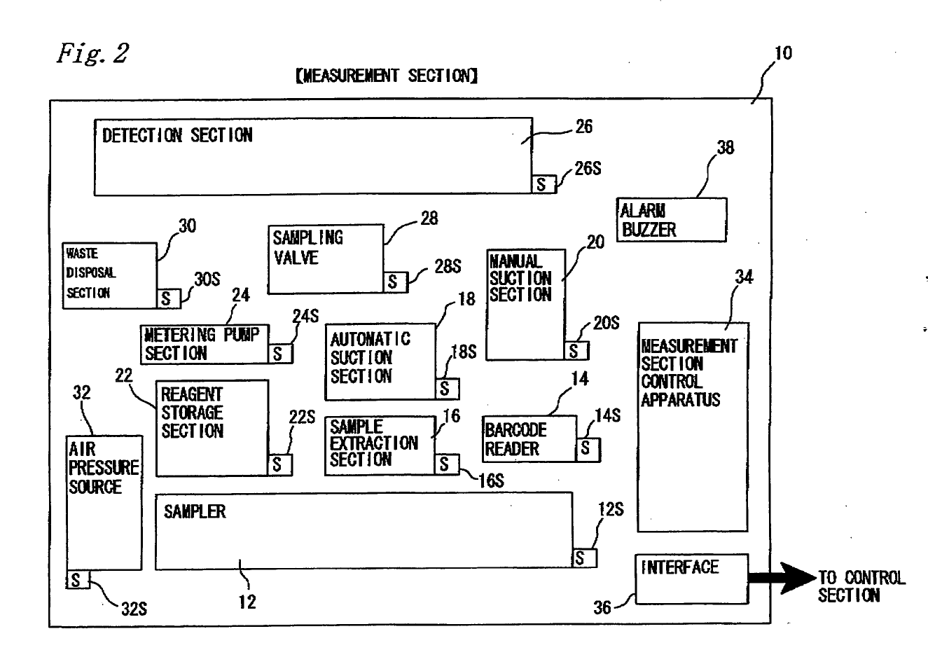

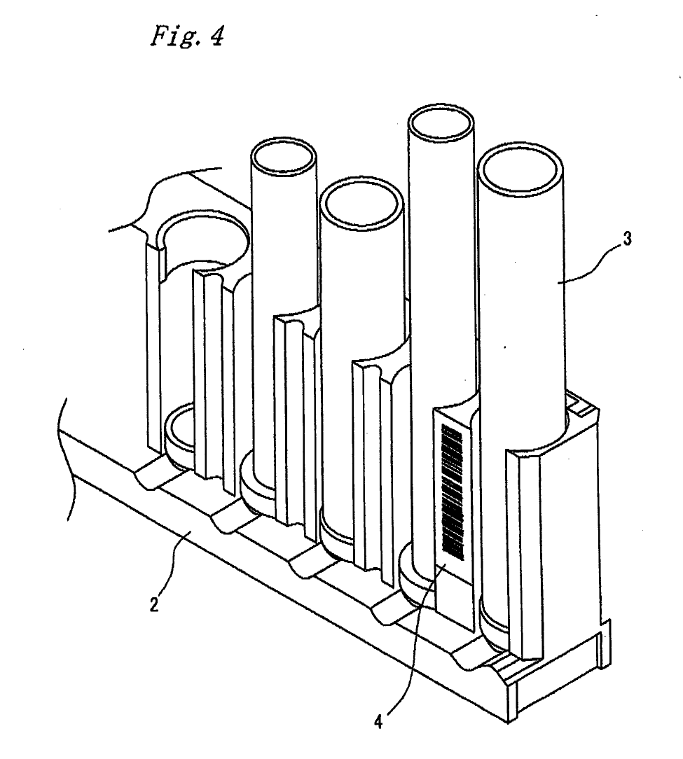

FIG. 2 shows the configuration of the measurement section 10 of the multi-item automatic blood cell analyzer 1. This apparatus can analyze blood collected into a sample container 3 having a variety of shapes housed in a sample rack 2 as shown in FIG. 4.

A barcode 4 is affixed to the sample rack 2 and necessary information such as information on the blood and information on the sample container is recorded as coded information in this barcode 4.

The measurement section 10 as shown in FIG. 2 is constructed of a sampler 12 for automatically setting the sample rack 2 in a predetermined position, a barcode reader 14 which reads the barcode 4 affixed to the sample rack 2, a sample extraction section 16 which extracts the sample container 3 from the sample rack 2, an automatic suction section 18 which automatically suctions the sample (blood) from the extracted sample container 3, a manual suction section 20 which suctions the sample from the sample container 3 manually set (without using an automatic suction section for the purpose of carrying out a special inspection or the like), a reagent storage section 22 which stores a plurality of reagents, a metering pump section 24 which extracts the reagent necessary for inspection from the reagents stored in the reagent storage section 22, a detection section 26 which measures the blood cell count item, differential white blood count item and reticulated blood cell item, a sampling valve 28 which determines a necessary amount of reagent and sample and send it into the detection section 28, a waste disposal section 30 for temporarily storing and discharging the measured reagent and sample, an air pressure source 32 which supplies pressure to each of the sections requiring pressured gas such as the valve, various sensors (sensor 12S to sensor 32S) provided for these sections (the respective sections are called “components” when their respective functions are not distinguished) for monitoring their operation statuses, a measurement section control apparatus 34 for integrating information from the sensors and controlling operations of the sections in the measurement section 10 and an interface section 36 for connecting the measurement section control apparatus 34 to the system control section 50 according to TCP/IP. The measurement section 10 is also provided with an alarm buzzer 38 for outputting an alarm sound upon receiving a signal through the measurement section control apparatus 34 when trouble occurs at each section or outputting an alarm sound (also called “error sound”) when the system control section, which will be described later, judges that an input is not appropriate.

Therefore, the measurement section 10′is assembled with the above described respective sections (components) cooperating with each other so as to be able to execute operation necessary for measurement.

Furthermore, the measurement section 10 can send the measurement result and other information to the system control section 50 and receive operation commands and other information from the system control section 50.

Illustrations of electric wiring for connecting the respective sections (components), channels for the reagents and sample and a pressure tube which supplies a pressure will be omitted.

[Configuration of System Control Section (Processing Computer)]

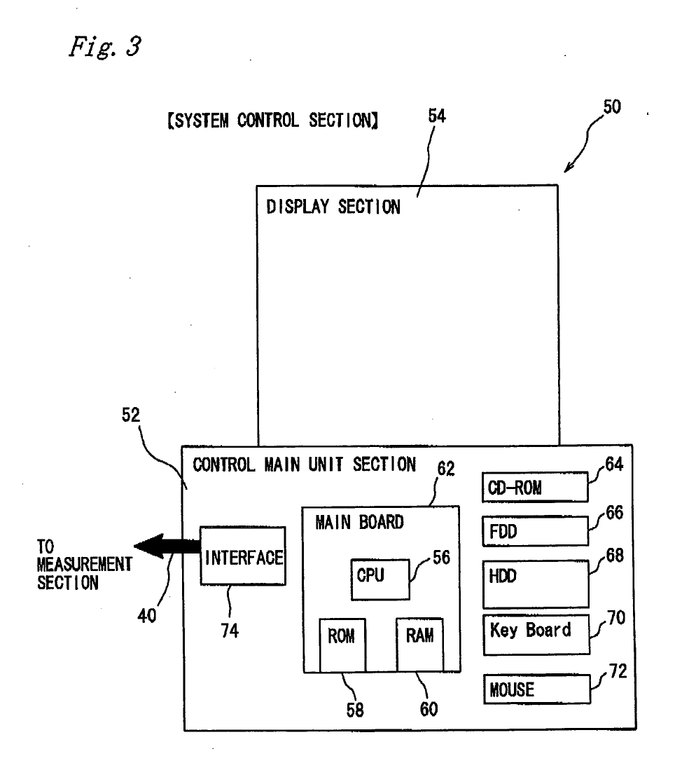

FIG. 3 shows the configuration of the system control section (processing computer) 50 of the multi-item automatic blood cell analyzer 1 This system control section 50 is mainly provided with a control main unit section 52 and a display section (display device) 54 and carries out analysis processing on the measurement result received from the measurement section, processing of displaying an operation screen of the whole multi-item automatic blood cell analyzer 1 on the display section 54 and other processing.

The control main unit section 52 includes a main board 62 mounted with a CPU 58, a ROM 58 and a RAM 60, a CD-ROM drive B4, a floppy (registered trademark) disk drive 66 and a hard disk drive 68. Furthermore, the control main unit section 52 is provided with a keyboard 70 and a mouse 72 as input sections. The control main unit section 52 is further provided with an interface 74 for connection with the measurement section 10 according to TCP/IP.

A commercially available personal computer which installs Windows2000 (trademark) as the OS can be used for this control main unit section 52.

A 17-inch TFT color liquid crystal display device is used for the display section 54, but the display section is not limited to this and a CRT display device may also be used. Furthermore, a touch screen provided with an input function may also be used for the display section 54.

The display section 54 displays an operation screen including various icons for inputting instructions for causing the multi-item automatic blood cell analyzer 1 to execute various operation controls. Data input becomes possible through operation of clicking on these icons using the mouse 72. For example, by specifying an icon, the user can select an operation mode and also based on the selection by the user, an operation instruction can be output to the measurement section 10 through the interface section 74. Furthermore, it is possible to receive an analysis signal, operation condition signal of the apparatus or the like sent from the measurement section 10 through the interface section 74 and display the analysis result of the sample and the operation condition of the apparatus on this display section 54.

The above described operation control, that is, a series of operation control such as display of various icons on the display section 54, selection of an operation mode by the user, output of an operation instruction, reception of an analysis signal sent from the measurement section and an operation condition signal of the apparatus or display of the analysis result is executed by a control program installed in the HDD (hard disk) 68. This control program is an application program operating under Windows2000 and may be preinstalled in the HDD 68 or one which is delivered in the form of a CD-ROM and installed by a user or serviceman.

By adopting an application program which operates under Windows2000 as a control program, a general-purpose computer can be used for the hardware of the personal computer which makes up the system control section 50 and the user can provide it. Furthermore, allowing the user to install the control program can make a revision of the control program easier.

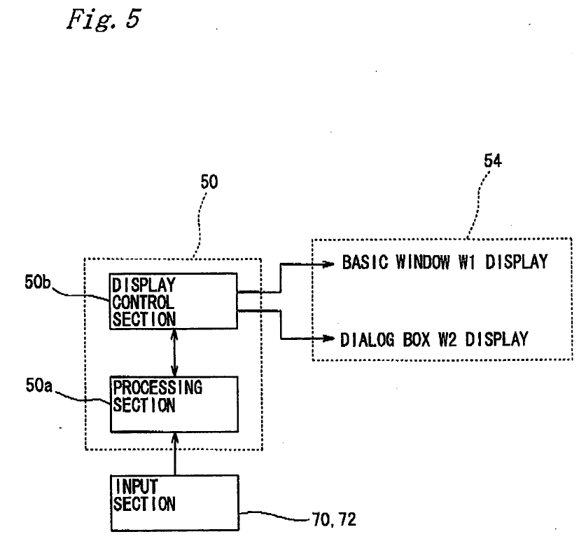

According to the control program, the system control section 60 receives a measurement result of the measurement section 10 as shown in FIG. 5 and functions as a processing section 80a which performs various types of processing including analysis processing based on the measurement result and a display control section (display control means) 50b which performs display control of the operation screen of the analyzer 1.

[Configuration of Operation Screen]

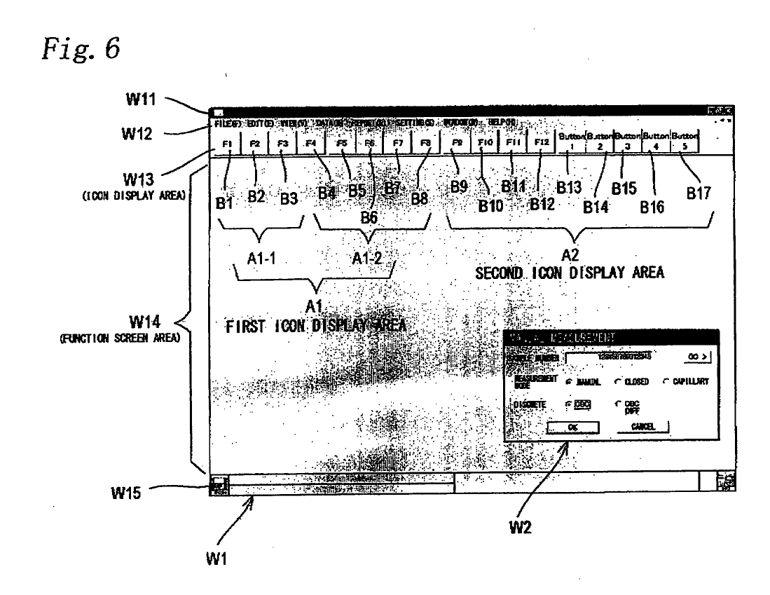

FIG. 6 shows the basic configuration of an operation screen of the analyzer 1 which is displayed on the display section 54.

As the operation screen, a basic window W1 including the area of function screens corresponding to various functions of the analyzer and an area (dialog box) W2 of a screen for a dialog with the measurement section 10 can be displayed.

The basic window W1 is provided with a title bar W11, a menu bar W12, a toolbar (icon display area) W13, a view (function screen area) W14 and a status bar W15 in that order from the top. The title bar W11 displays the name of a window or the like. Items such as “File” and “Edit” which become basic operation menus of the basic window W1 are arranged on the menu bar W12.

Toolbar buttons (icons) B1 to B17 for executing predetermined functions are arranged on the toolbar W13.

The view W14 is the area for changing and displaying a plurality of function screens corresponding to various functions of the analyzer 1.

Eight left side buttons B1 to B8 on the above described toolbar W13 are the ones which are commonly displayed no matter what type of function screen is displayed in the view W14 and the area where these buttons B1 to B8 are arranged is designated as a first icon display area (common icon display area) A1.

On the other hand, remaining nine right side buttons B9 to B17 are the ones which are changed and displayed for each function screen which is displayed in the view W14 and the area where these buttons B9 to B17 are arranged is designated as a second icon display area (changed icon display area; area for the second icons) A2.

In FIG. 6, the 12 left side buttons B1 to B12 displayed as F1 to F12 are associated with function keys F1 to F12 of the keyboard 70 and these buttons B1 to B12 can be selected not only by selection operation (click) with the mouse 72 but also by operation of pressing the correspond function keys of the keyboard 70. The buttons B13 to B17 can be selected only by the selection operation with the mouse 72 but may also be made selectable through the key operation of the keyboard 70 in the same way as for the buttons B1 to B12.

The first icon display area (common icon display area) A1 is further divided into a dialog icon area (area for third icons) area A1-1 to which dialog icons (third icons) B1 to B3 belong and a function screen icon area (area for the first icons) A1-2 to which the function screen icons (first icons) B4 to B8 belong.

The functions of the respective buttons B1 to B8 in the first icon display area A1 are shown in following Table 1.

TABLE 1

| BUTTON | FUNCTION KEY | NAME | FUNCTION |
|---|---|---|---|
| B1 | F1 | HELP | OPENS MEASUREMENT SECTION HELP DIALOG |
| B2 | F2 | MANUAL | OPENS MANUAL MEASUREMENT DIALOG |
| B3 | F3 | SAMPLER | OPENS SAMPLER MEASUREMENT DIALOG |
| B4 | F4 | MENU | OPENS MENU SCREEN |
| B5 | F5 | QC FILE | OPENS QC FILE SCREEN |
| B6 | F6 | REGISTER MEASUREMENT | OPENS REGISTER MEASUREMENT SCREEN |
| B7 | F7 | EXPLORER | OPENS SAMPLE EXPLORER SCREEN |
| B8 | F8 | BROWSER | OPENS BROWSER SCREEN |

As shown in Table 1, “Help” icon B1, “Manual (measurement)” icon B2 and “Sampler (measurement)” icon B3 are provided as the dialog icons (third icons) B1 to B3 arranged in the dialog icon area A1-1. The details of these dialog icons B1 to B3 and the dialog box (dialog screen) W2 displayed by these icons B1 to 83 will be described later.

Likewise, as shown in Table 1, “Menu” icon B4, “QC file” icon B5, “Register measurement” icon B2, “Explorer” icon B7, “Browse” icon B8 are provided as the function screen icons (first icons) B4 to B8 arranged in the function screen icon area A1-2.

[Type of Icon]

Next, the types of icons (including icons (buttons) already explained) displayed on the operation screen of the analyzer 1 will be explained.

As the icons used on the operation screen, the analyzer 1 of this embodiment provides first icons, second icons, third icons and fourth icon and these icons are stored in the memory of the system control section 50 and are displayed by the display control section 50b as appropriate.

[First Icon]

The first icons are intended to call up function screens provided in correspondence with the various types of functions of the analyzer 1 and display them in the view (function screen area) W14 of the basic window W1.

As shown in Table 2 and Table 3 below, there are function screens which are called up when the first icons are selected such as a “Menu” screen which displays an operation menu, “QC file” screen which shows a list of data of quality control (QualityControl), “QC chart” screen which shows the result of quality control, “Register measurement” screen which registers the contents which should be measured by the measurement section, “Sample explorer” screen which shows a list of sample measurement results, “Data browser” screen which shows details of the sample measurement result, “Reagent replacement history” screen which shows the replacement history of reagents at the measurement section 10, “Operation history” screen which shows an operation history,. “Patient registration” screen which registers patients to be measured and analyzed, “Doctor registration” screen which registers doctors, “Ward registration” screen which registers wards, “GP (GraphicPrinter) customize” screen which sets a print layout of measurement/analysis results, “Calibration history” screen which displays a calibration history, “PreCheckList” screen which displays a pre-checklist and “Error history” screen which displays an error history, and the first icons corresponding to the respective function screens are associated therewith respectively,

TABLE 2

| | COMMON TO ALL SCREENS AT | | | | | | | |
|---|---|---|---|---|---|---|---|---|
| SCREEN | F1 | F2 | F3 | F4 | F5 | F6 | F7 | F8 |
| MENU | HELP | MANUAL | SAMPLER | MENU | QC FILE | REGISTER MEASUREMENT | EXPLORER | BROWSER |
| QC FILE | HELP | MANUAL | SAMPLER | MENU | QC FILE | REGISTER MEASUREMENT | EXPLORER | BROWSER |
| QC CHART | HELP | MANUAL | SAMPLER | MENU | QC FILE | REGISTER MEASUREMENT | EXPLORER | BROWSER |
| REGISTER | HELP | MANUAL | SAMPLER | MENU | QC FILE | REGISTER MEASUREMENT | EXPLORER | BROWSER |
| MEASUREMENT | | | | | | | | |
| EXPLORER | HELP | MANUAL | SAMPLER | MENU | QC FILE | REGISTER MEASUREMENT | EXPLORER | BROWSER |
| BROWSER | HELP | MANUAL | SAMPLER | MENU | QC FILE | REGISTER MEASUREMENT | EXPLORER | BROWSER |
| REAGENT REPLACEMENT | HELP | MANUAL | SAMPLER | MENU | QC FILE | REGISTER MEASUREMENT | EXPLORER | BROWSER |
| HISTORY | | | | | | | | |
| OPERATION HISTORY | HELP | MANUAL | SAMPLER | MENU | QC FILE | REGISTER MEASUREMENT | EXPLORER | BROWSER |
| REGISTER PATIENT | HELP | MANUAL | SAMPLER | MENU | QC FILE | REGISTER MEASUREMENT | EXPLORER | BROWSER |
| REGISTER DOCTOR AND | HELP | MANUAL | SAMPLER | MENU | QC FILE | REGISTER MEASUREMENT | EXPLORER | BROWSER |
| WARD | | | | | | | | |
| GP CUSTOMIZE | HELP | MANUAL | SAMPLER | MENU | QC FILE | REGISTER MEASUREMENT | EXPLORER | BROWSER |
| CALIBRATION HISTORY | HELP | MANUAL | SAMPLER | MENU | QC FILE | REGISTER MEASUREMENT | EXPLORER | BROWSER |
| PRE CHECK LIST | HELP | MANUAL | SAMPLER | MENU | QC FILE | REGISTER MEASUREMENT | EXPLORER | BROWSER |
| ERROR HISTORY | HELP | MANUAL | SAMPLER | MENU | QC FILE | REGISTER MEASUREMENT | EXPLORER | BROWSER |

TABLE 3

| | FOR EACH SCREEN A2 | | | | | | | | |
|---|---|---|---|---|---|---|---|---|---|
| SCREEN | F9 | F10 | F11 | F12 | Button 1 | Button2 | Button3 | Button4 | Button5 |
| MENU | DESIGN | ARRANGE | | | | | | | |
| QC FILE | INPUT | | QC CHART | | UP | DOWN | LATEST | | DELETE |
| | | | | | | | ORDER | | |
| QC CHART | INPUT | VIAL | SUPERIMPOSE | OUTPUT | UP | DOWN | SORT | SHIFT | DELETE |
| REGISTER | REGISTER | CORRECT | DOWNLOAD | OUTPUT | UP | DOWN | SORT | UNMEASURED | DELETE |
| MEASUREMENT | | | | | | | | | |
| EXPLORER | CHANGE | CORRECT | VALIDATE | OUTPUT | UP | DOWN | SORT | LATEST 20 | DELETE |
| BROWSER | DISPLAY | | VALIDATE | OUTPUT | UP | DOWN | | LATEST 20 | DELETE |
| REAGENT | INPUT | | | OUTPUT | UP | DOWN | | | |
| REPLACEMENT | | | | | | | | | |
| HISTORY | | | | | | | | | |
| OPERATION | INPUT | | | | UP | DOWN | | | |
| HISTORY | | | | | | | | | |
| REGISTER PATIENT | REGISTER | CORRECT | | | UP | DOWN | SORT | | DELETE |
| REGISTER DOCTOR | REGISTER | CORRECT | | | UP | DOWN | | | DELETE |
| AND WARD | | | | | | | | | |
| GP CUSTOMIZE | SAVE | | | | | | | | |
| CALIBRATION | | | | OUTPUT | UP | DOWN | | | DELETE |
| HISTORY | | | | | | | | | |
| PRE CHECK LIST | | | | OUTPUT | UP | DOWN | | | DELETE |
| ERROR HISTORY | | | | | UP | DOWN | | | DELETE |

[Second Icon]

The second icons are intended to execute the operations on function screens which are called up and displayed with the first icons. As shown in Table 3 above, the second icons are grouped as second icon groups associated with the respective function screens (first icons) to be operated.

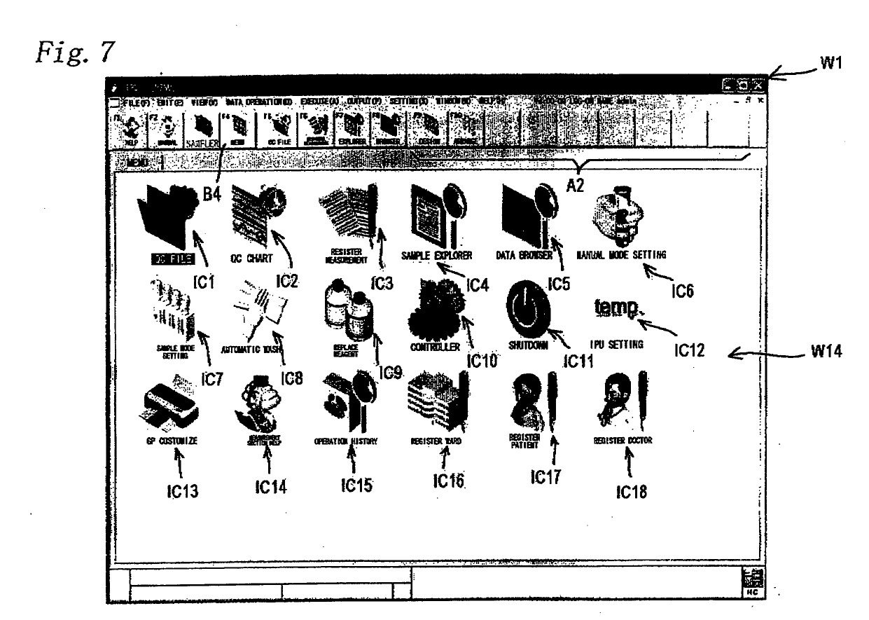

For example, there are second icons which make up the second icon group for the “Menu” screen such as a “Design” icon which controls the design of the menu screen and a “Arrange” icon which arranges icons on the menu screen (also see the second icon display area A2 in FIG. 7).

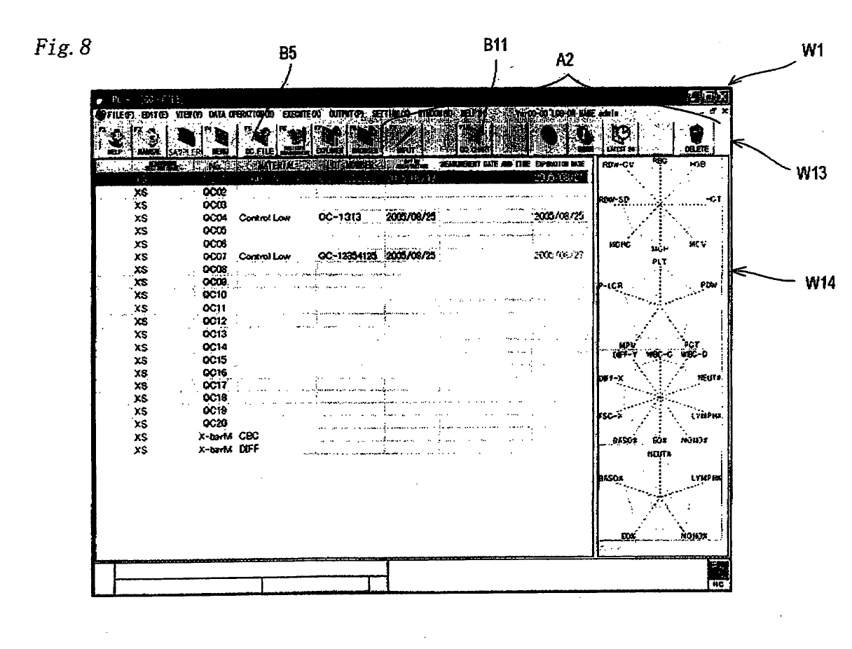

Furthermore, there are second icons which make up the second icon group for the “QC file” screen such as an “input” icon for inputting a quality control substance, “Up” icon for moving up a selection in a list, “Down” icon for moving down a selection in a list, “Latest order” icon for sorting the list in order from the latest one and “Delete” icon for deleting quality control substances which are displayed as being selected from the list (also see the second icon display area A2 of FIG. 8).

In Table 3, the “QC chart” icon included in the icon group associated with the “QC file” screen is intended to display the QC chart screen of a quality control substance which is displayed as being selected out of the quality control substances displayed as a list on the “QC file” screen and is a first icon in the sense that it displays the “QC chart screen” which is a function screen.

In this way, the icons displayed in the second icon display area A2 include not only the second icons but also the first icons. This reason will be described later in the explanation of the “QC file” screen in FIG. 8.

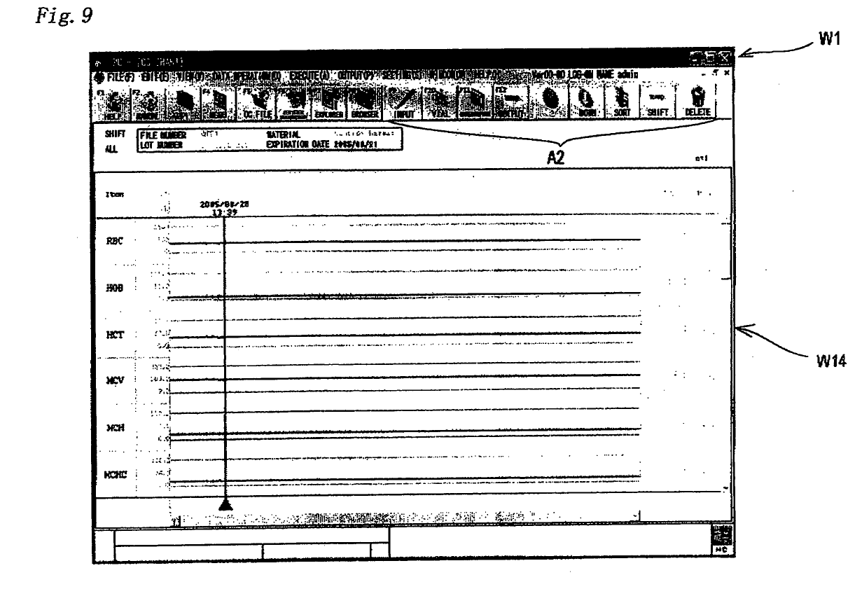

The second icons which make up the second icon group for the “QC chart” screen include an “input” icon for inputting a quality control substance, “Vial” icon for adding a vial line into the QC chart, “Superimpose” icon for displaying QC charts superimposed, “Output” icon for outputting a QC chart, “Up” icon for moving up a selection, “Down” icon for moving down a selection, “Sort” icon for sorting a list, “Shift” icon for filtering and displaying work shifts of persons in charge who perform quality control processing and “Delete” icon for deleting (also see the second icon display area AZ of FIG. 9).

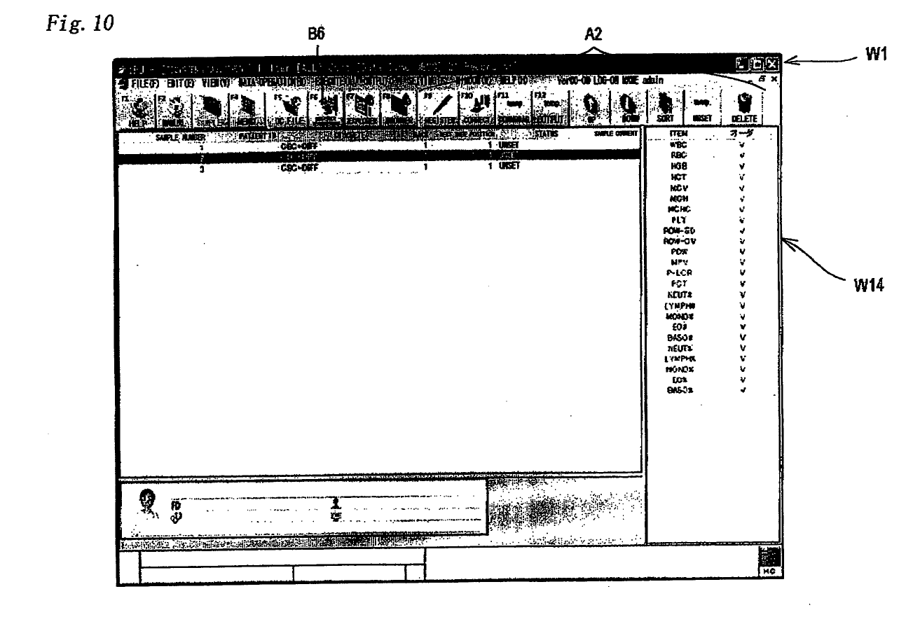

The second icons which make up the second icon group for the “Register measurement” screen include a “Register” icon for registering measurement contents, “Correct” icon for correcting registration contents, “Download” icon for downloading registration contents from other devices (host computer or the like) over a network, “Output” icon for outputting the registration contents to other devices (printer, host computer or the like), “Up” icon for moving up a selection in a list, “Down” icon for moving down a selection in a list, “Sort” icon for sorting the list, “Unmeasured” icon for filtering and displaying data whose registration status is unmeasured yet, and “Delete” icon for deleting registration contents (also see the second icon display area A2 of FIG. 10).

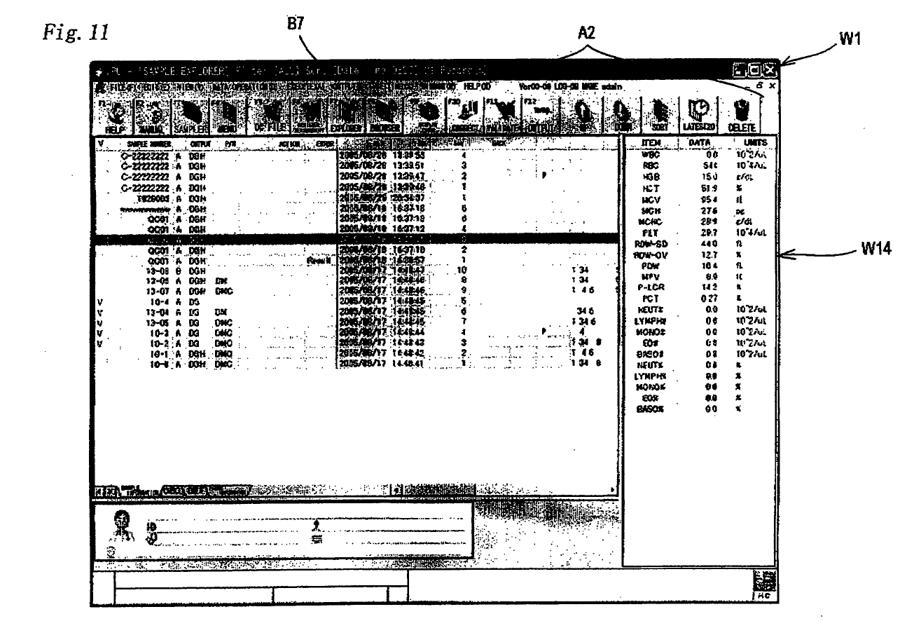

The second icons which make up the second icon group for the “Sample explorer” screen include a “Change display” icon for changing the display format of a list of measurement results, “Correct” icon for correcting a list display, “Validate” icon for validating, “Output” icon for outputting the list to other devices (printer, host computer or the like), “Up” icon for moving up a selection in a list, “Down” icon for moving down a selection in a list, “Sort” icon for sorting the list and “Latest 20” icon for filtering and displaying the 20 latest measurement results and “Delete” icon for deleting a measurement result (also see the second icon display area A2 of FIG. 11),

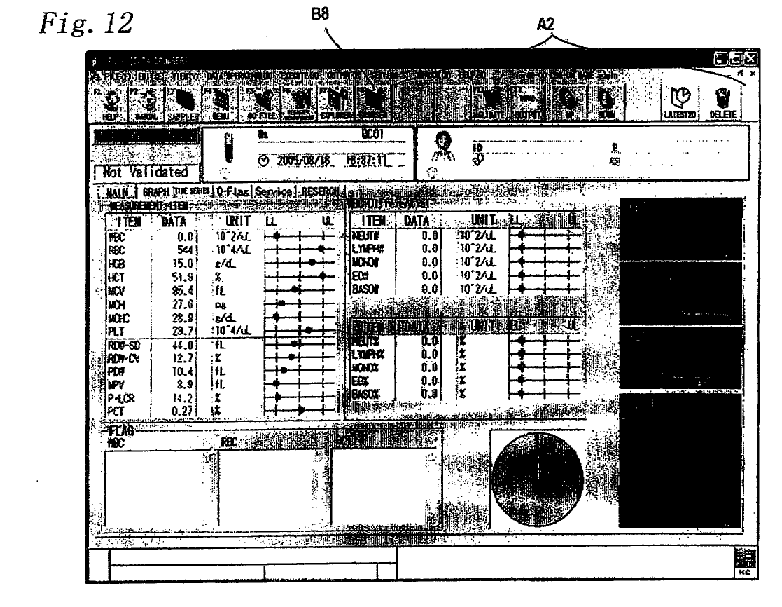

The second icons which make up the second icon group for the “Data browser” screen include a “Validate” icon for validating, “Output” icon for outputting the details of measurement results to other devices (printer, host computer or the like), “Up” icon for moving up a selection, “Down” icon for moving down a selection, “Latest 20” icon for filtering and displaying the 20 latest measurement results and “Delete” icon for deleting a measurement result (also see the second icon display area AS of FIG. 12).

In the like manner, the second icon groups as shown in Table 3 are provided for the “Reagent replacement history” screen, “Operation history” screen, “Patient registration” screen, “Doctor registration” screen, “Ward registration” screen, “GP customize” screen, “Calibration history” screen, “PreCheckList” screen and “Error history” screen.

[Third Icon]

The third icons are intended to display the dialog box (dialog screen) W2 for the user to carry out a dialog with the measurement sections 10 through the system control section (processing computer) 50. The system control section 50 serves as an interface between the measurement section 10 and the user through a dialog box, carrying out a communication between the system control section 50 and measurement section 10 so as to allow the system control section 50 to give a command to the measurement section 10 according to the user's operation or allow the system control section 50 to acquire information from the measurement section 10 and display it for the user.

Here, the third icons do not change and display the function screen displayed in the view W14 of the basic window W1 as in the case of the first icons, but displays the dialog box W2 which is a window different from the basic window W1 without changing the view W14.

As the third icons, there are “Measurement section-help” icon for acquiring and displaying an error condition at the measurement section 10, “Manual measurement” icon for giving an instruction for starting measurement in the manual mode, “Sampler measurement” icon for giving an instruction for starting measurement in the sampler mode, “Automatic wash” icon giving an instruction for starting automatic washing at the measurement section 10, “Replace reagent” icon for giving an instruction for replacing a reagent at the measurement section 10, “Shutdown” icon for giving an instruction for turning OFF power to the measurement section 10 and “IPU setting” icon for giving an instruction for setting the processing computer (IPU).

[Fourth Icon]

As the fourth icon, there is a “controller” icon. This “controller” icon” is intended to display and call up the “Controller” screen to display a list of icons to call up history-related screens such as the “Reagent replacement history” screen, “Operation history” screen, “Calibration history”, “PreCheckList” screen and “Error history” screen out of the first icons on the view W14. Unlike the first icons, the second icon groups are not associated with the fourth icon.

[Example of Basic Window Display]

FIG. 7 to FIG. 13 show examples of the display of the basic window W1.

The basic window W1 shown in FIG. 7 to FIG. 13 shows screens of various functions of the analyzer 1 and is a part of a plurality of function screens which are called up by the first icons.

It can be appreciated that the display of the first icon display area (common icon display area) A1 of the toolbar W13 on the screen shown in FIG. 7 to FIG. 13 is common and fixedly displayed in the respective figures. Here, the operating efficiency of the icons is high because icons used with a high frequency are fixed in the first icon display area A1.

On the other hand, the display in the view (function screen area) W14 shown in FIG. 7 to FIG. 13 and the display of the second icon display area (changed icon display area) A2 of the toolbar W13 differ from one function to another, and so differ from one figure to another. In this way, though the analyzer 1 has multiple functions and has many icons, only necessary icons are displayed as icons displayed when one function screen is displayed and there are only a few such icons and the icons are shown in a simple layout. Moreover, since the number of icons is small, each icon can be displayed in enlarged size, providing excellent operability.

Moreover, the operability is also improved in the sense that the left side of the toolbar W13 is fixedly displayed while the right side is changed and displayed.

In FIG. 7 to FIG. 13, buttons B1 to B17 are composed of characters and graphics which represent functions. Selecting the button B1 to B17 of the toolbar W13 causes the function associated with the button to be executed. Here, the execution of a function by selecting a button also includes execution of the function by displaying a tool pop-up window for selecting and executing a plurality of functions associated with the button and then performing a predetermined selection on the tool pop-up window.

In FIG. 7 to FIG. 13, the measurement section 10 is not furnished with the sampler 12, which is displayed light-colored (gray display; not highlighted) so that the “sampler” icon B2 cannot be selected in this condition.

FIG. 7 shows the window W1 when the “Menu” icon 84 which is one of the first icons (function screen icons) is selected and the view W14 of this window W1 displays the “Menu” screen as the function screen for the operation menu display function which is one of the functions of the analyzer 1. This “Menu” screen is the screen which is displayed soon after a multi-item automatic blood cell analyzer is started up. Also, the user selects an icon in the screen, and can thereby change the display to another one.

This “Menu” screen is provided with a plurality of icons IC1 to IC18 for executing the functions of the analyzer 1 other than the menu display function. Out of the icons IC1 to IC18 of the “Menu” screen, some icons IC1, IC3, IC4, IC5, IC6, IC7, IC14 are used to execute the same functions as those of the buttons (icons) B1, B2, B3, B5, B6, B7, B8 which are fixedly displayed in the first icon display area A1 of the toolbar W13 and also have substantially common icon designs.

In other words, it can be said that of the icons IC1 to IC18 of the “Menu” screen, shortcuts of icons which are used with a high frequency (icons used with a high frequency in normal measurement/analysis operations by the analyzer 1) are displayed in the first icon display area A1 (together with shortcuts of icons for displaying the “Menu” screen).

Therefore, even if the “Menu” screen is not opened, it is possible to select icons which are used frequently using the toolbar W13 and high operating efficiency is provided.

Here, of the icons IC1 to IC18 displayed on the “Menu” screen, icons IC1, IC2, IC3, IC4, IC5, IC13, IC15, IC16, 1C17, IC18 are the first icons, while icons IC0, IC7, IC8, IC9, IC11, IC12, IC14 are the third icons and icon IC10 is the fourth icon.

FIG. 8 shows the window W1 when the “QC file” Icon B5 which is one of the first icons (function screen icons) is selected and the view W14 of this window W1 shows the “QC file” screen as the function screen for the quality control result list display function which is one of the functions of the analyzer 1.

A list of quality control results is displayed on the left side of this “QC file” screen and the latest measurement results of quality control substances which are selected in the result list are displayed in radar charts on the right side. The user selects other measurement results in the list by clicking on them with the mouse or key input from the keyboard, and can thereby cause the selected measurement results to be displayed in the radar charts.

In FIG. 8, not only the second icons but also the “QC chart” icon which is a first icon as the button B11 but which is not shown in the first icon display area A1 is displayed in the second icon display area A2 which is changed and displayed. When this “QC chart” icon B11 is selected, the window Q1 shown in FIG. 9 is displayed. The view W14 of this window W1 displays the “QC chart” screen as the function screen for the detailed information display function of the quality control result which is one of the functions of the analyzer 1.

The “QC chart” screen displays time variations or the like of the measurement result: of quality control substance for each measurement item.

Though the “QC file” screen and “the QC chart” screen are separate function screens, in the sense that the “QC chart” screen displays detailed information on the quality control substance which is selected in the list of the “QC file” screen, both screens of FIG. 8 and FIG. 9 are function screens closely related to each other.

In this way, by displaying the icons to call up the other function screen (QC chart screen) which is related to one function screen (QC file screen) in the second icon display area which is changed and displayed, it is possible to efficiently display the other function screens.

FIG. 10 shows the window W1 when the “Register measurement” icon B0 which is one of the first icons (function screen icons) is selected and the view W14 of this window W1 displays the “Register measurement” screen as the function screen for the measurement content registration function which is one of the functions of the analyzer 1.

A list of measurement registration contents is displayed on the left side of this “Register measurement” screen, the contents of measurement order of a sample selected from the list are displayed on the right side and checkmarks “V” are displayed in the measurement items (ITEM) that require measurement.

FIG. 11 shows the window W1 when the “Sample explorers icon B7 which is one of the first icons (function screen icons) is selected and the view W14 of this window W1 displays the “Sample explorer” screen as the function screen for the sample measurement result list display function which is one of the functions of the analyzer 1.

A list of the sample measurement results is displayed on the left side of this “Sample explorer” screen and measurement results for each measurement item of the sample selected in the list is displayed on the right side.

FIG. 12 shows the window W1 when the “Data browser” icon B8 which is one of the first icons (function screen icons) is selected and the view W14 of this window W1 displays and the “Data browser” screen as the function screen for the sample measurement result detail display function which is one of the functions of the analyzer 1.

This “data browser” screen shows the details of the measurement result of the sample selected in the sample measurement result list which is shown in FIG. 11 in forms of numerical values, scattergram, graph or the like.

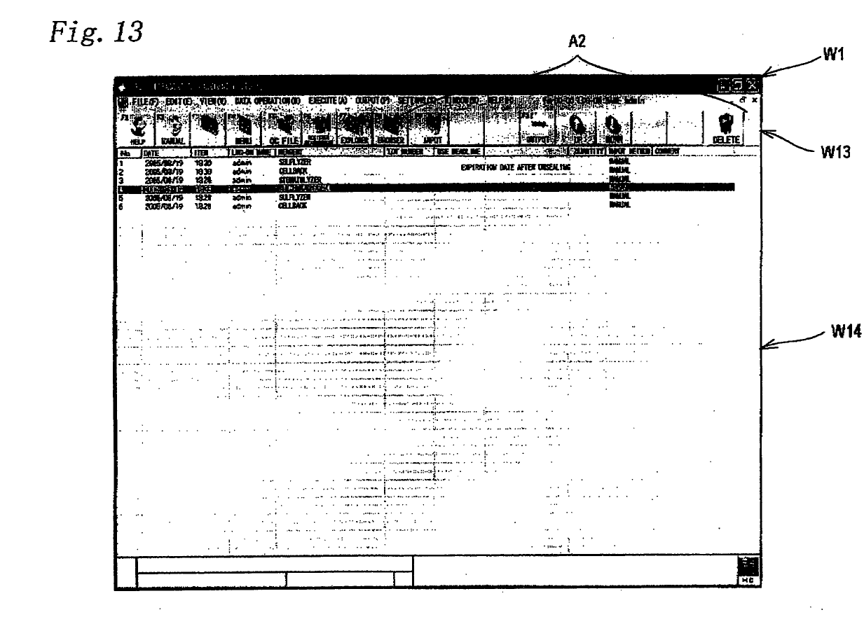

FIG. 13 shows the window W1 when the “Reagent replacement history” icon which is one of the first icons (function screen icons) is selected. This “Reagent replacement history” is a first icon but is not displayed on the toolbar W13 and is an icon which is displayed on the control screen which is displayed by selecting the “Control” icon IC11 of the “Menu” screen in FIG. 7.

Even when such an icon is selected, as in the case of the first icons displayed in the first icon display area A1 of the toolbar W13, the view W14 of the window W1 displays the “Reagent replacement history” screen as the function screen for the reagent replacement history display function which is one of the functions of the analyzer 1 and the second icon group corresponding to the “Reagent replacement history” shown in Table 3 is also displayed in the second icon display area A2.

[Arrangement of Icons in Second Icon Display Area A2]

As shown in Table 3 and FIG. 7 to FIG. 13, to facilitate operation even when the display is changed, the icons having the same functions or the icons comparatively common between the changed screens are assigned to the same buttons of the buttons B9 to B17 in the second icon display area A2.

For example, the “Output” icon is assigned to the button B12, the “Up” icon is assigned to the button B13, the “Down” icon is assigned to the button B14 and the “Delete” icon is assigned to the button B17.

Furthermore, icons related to the input/registration are gathered on the button B9, icons related to correction are gathered on B10, icons related to arrangement are gathered on B15 and icons related to filtering are gathered on B16.

As a result, in the toolbar display corresponding to the respective function screens, the effective buttons in the second icon display area A2 may not be displayed left-justified but these buttons may be spaced apart from each other.

In this way, by providing uniformity in the layout of icons on the respective screens, it is possible to provide the user with operability common to a plurality of screens,

[Display of Toolbar Button Selection]

As has already been described, the 12 left side buttons B1 to B12 displayed as F1 to F12 out of the buttons of the toolbar W13 are associated with the function keys F1 to F12 of the keyboard 70 which has a plurality of keys and these buttons can also be selected by pressing the corresponding function keys (input operation).

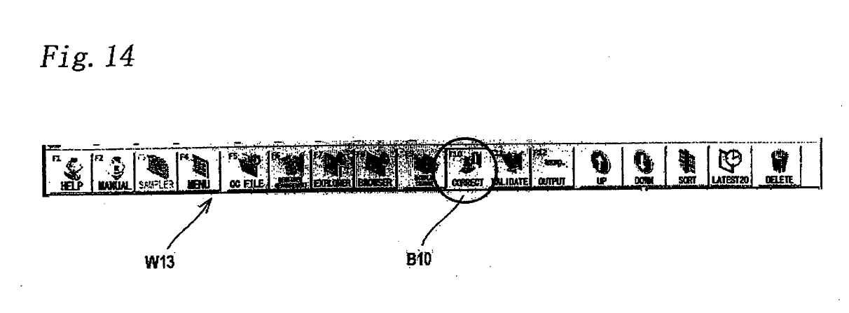

As shown in FIG. 14, when, for example, the button B10 is selected out of the buttons B1 to B12 with the mouse or by pressing the corresponding function keys F1 to F12, the selected button (icon) B10 in the display of the toolbar W13 is shown as being recessed (selected display) indicating that it is selected and when the selection is canceled, the original display is restored (unselected display).

In this way, by causing the display of an icon to be changed also through key operation of the keyboard 70, it is possible to prevent misoperation due to pressing of wrong keys.

[Explanation of Overview of Toolbar Button Functions]

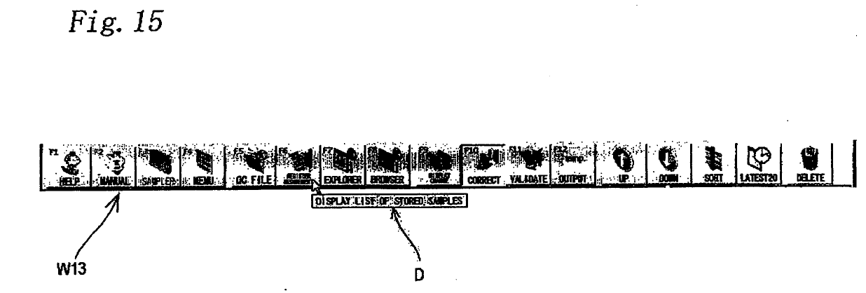

As shown in FIG. 15, when the mouse pointer is brought close to each of the buttons B1 to B17 of the toolbar W13, an overview display D of the function of the button is displayed and this facilitates the operation.

[Pop-Up Display]

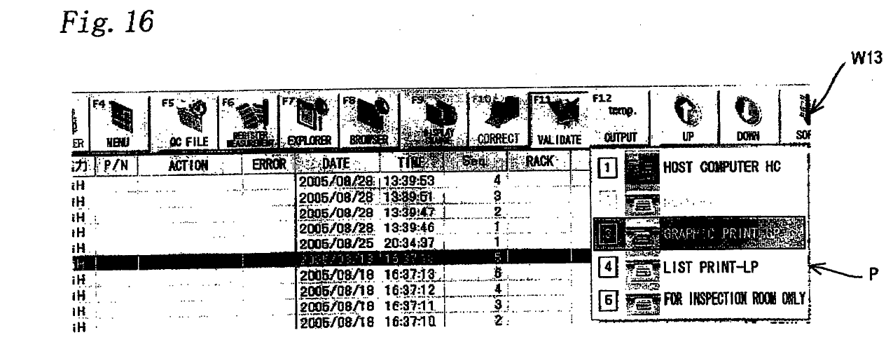

When the “Output” icon B12 of the toolbar W13 is selected as shown in FIG. 16, a pop-up window P for selecting the output destination is displayed. In this way, a plurality of mutually correlated functions such as a plurality of output functions which are only different in output destinations are gathered on a single button (icon) and the plurality of mutually correlated functions are displayed in a pop-up window and this facilitates the operation.

[Display of Whether Toolbar Button is Selectable or Not]

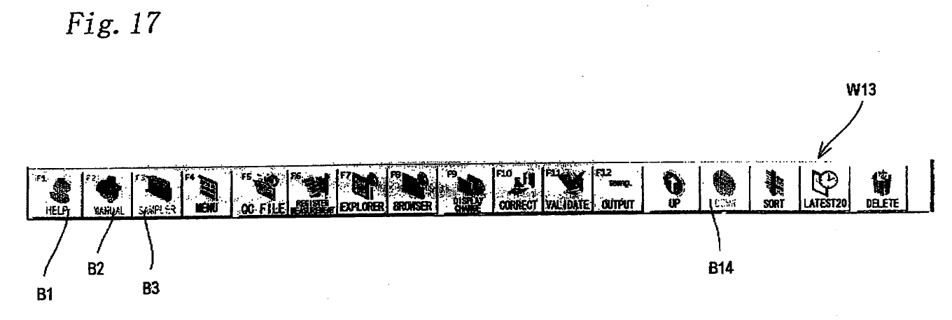

As shown in FIG. 17, though the buttons on the toolbar are shown, they may be selectable or may not be selectable. For example, in FIG. 17, the buttons B1 to B3 are shown light-colored (gray display) to indicate that they are not selectable because the measurement section 10 has not been started yet. Furthermore, the button B14 is shown light-colored (gray display) to indicate that the “Down” icon is not selectable because the item at the bottom of the list is selected.

On the other hand, the other buttons are shown highlighted to indicate that they are selectable, which makes the selectable buttons recognizable at a glance and provides excellent operability.

[Position Change of Toolbar]

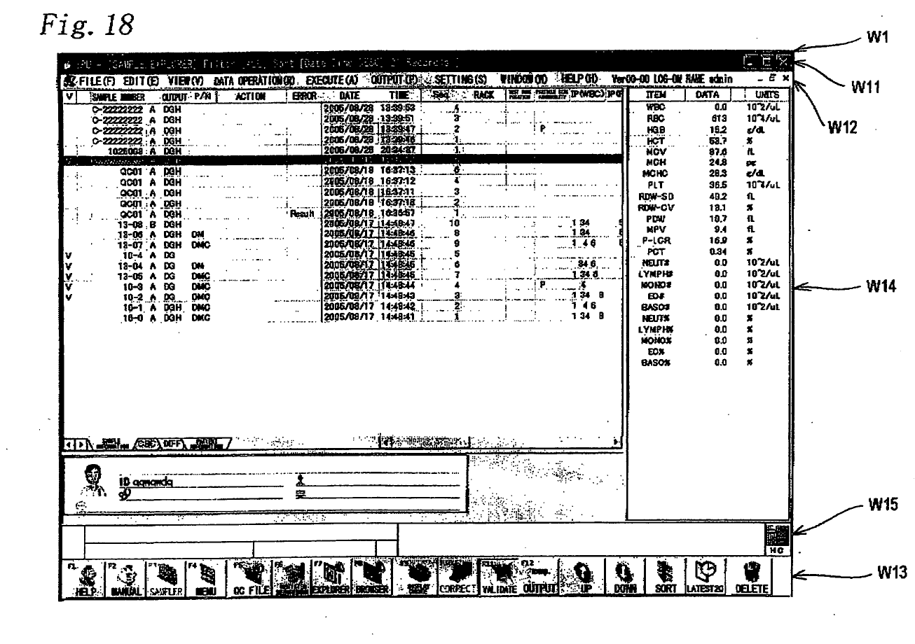

The position of the toolbar W13 can be changed to an arbitrary position other than the top of the basic window W1 such as the bottom, left or right of the basic window W as shown in FIG. 18. This allows the user to change the layout to an easy-to-use one. The position can be changed by dragging the toolbar W13 to a desired position with the mouse 72, for example.

[Floating Display of Toolbar]

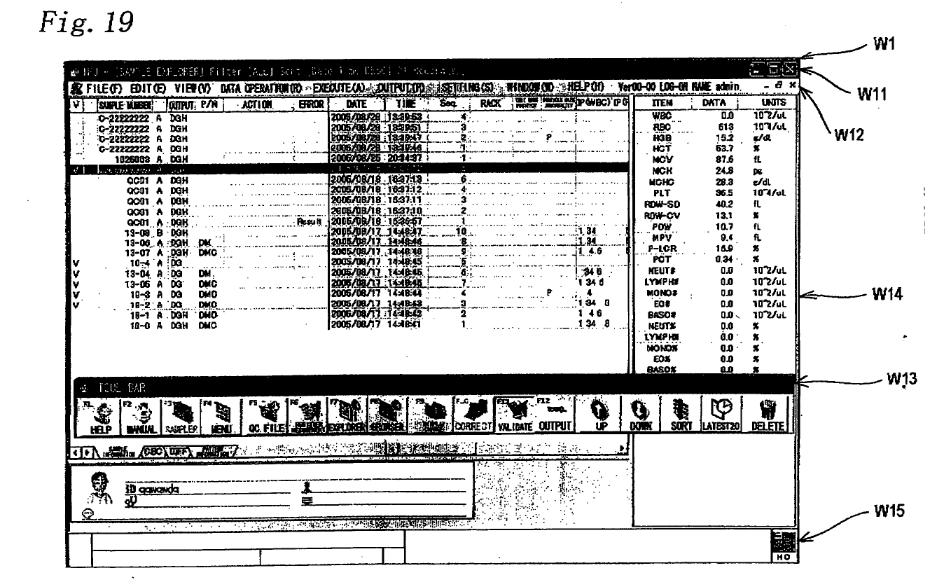

The toolbar W13 may be displayed not as part of the basic window W1 but as a window independent of the basic window W1 as a so-called “floating display” as shown in FIG. 19. This allows tee user to change the layout to an easy-to-use one.

[Function of Dialog Icon (Third Icon)]

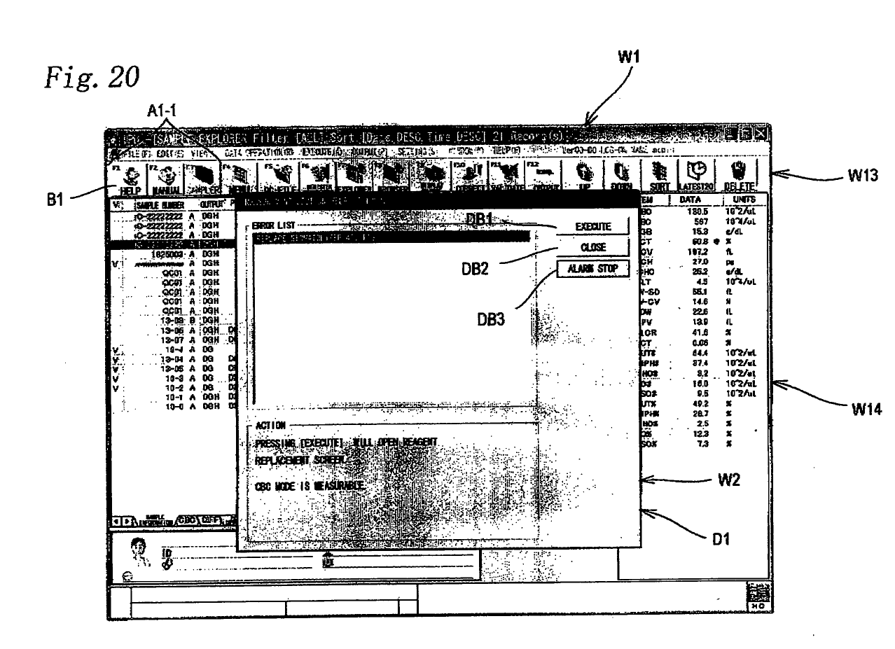

FIG. 20 to FIG. 22 show screens where dialog boxes (dialog screens) D1, D2 D3 are shown by selecting a dialog icon (third icon) which is arranged in the icon area A1-1 of the toolbar W13.

The dialog boxes D1, D2, D3 are used to receive information such as error information from the measurement section 10 or to send an instruction such as an instruction for starting a measurement and are displayed in a modaless manner (operations of other windows are not possible).

Furthermore, while the function screen (view W14) which is called up with the first icons is operated by the second icons in the second icon display area A2 of the toolbar W13, the operations of the dialog boxes D1, D2, D3 which are called up with the third icons are completed through other operations of the button DB1 to DB9 or the dialog box in dialog boxes D1, D2, D3 or other operations for operation displays in the dialog box.

Furthermore, the dialog boxes D1, D2, D3 are displayed in a window (dialog screen area) W2 which is different from the basic window W1, and therefore the display of the view W14 remains in the basic window W1 and when the processing by the dialog boxes D1, D2, D3 ends, it is possible to immediately return to the operation with the view W14.

[Display of Measurement Section Help Dialog (Measurement Section Error Screen)]

When an error such as a shortage of reagent occurs at the measurement section 10 and the alarm buzzer section 38 outputs an alarm and the user selects the “Measurement section help” icon B1 of the toolbar W13, the measurement section help dialog D1 shown in FIG. 20 is displayed.

The measurement section help dialog D1 allows the error contents to be acquired from the measurement section 10 and displayed.

[Display of Measurement Start instruction Dialog (Measurement Start Instruction Screen)]

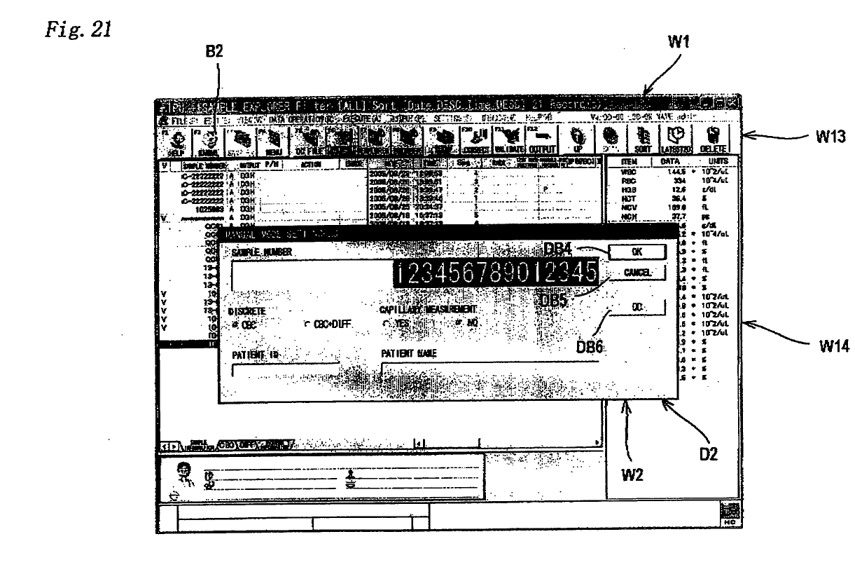

The manual measurement start instruction dialog (sample measurement start instruction screen) D2 for the sample shown in FIG. 21 is displayed when the “Manual measurement” icon B2 is selected while the “Sample explorer” screen (function screen related to the measurement of the sample) which displays a sample list is displayed in the view W14.

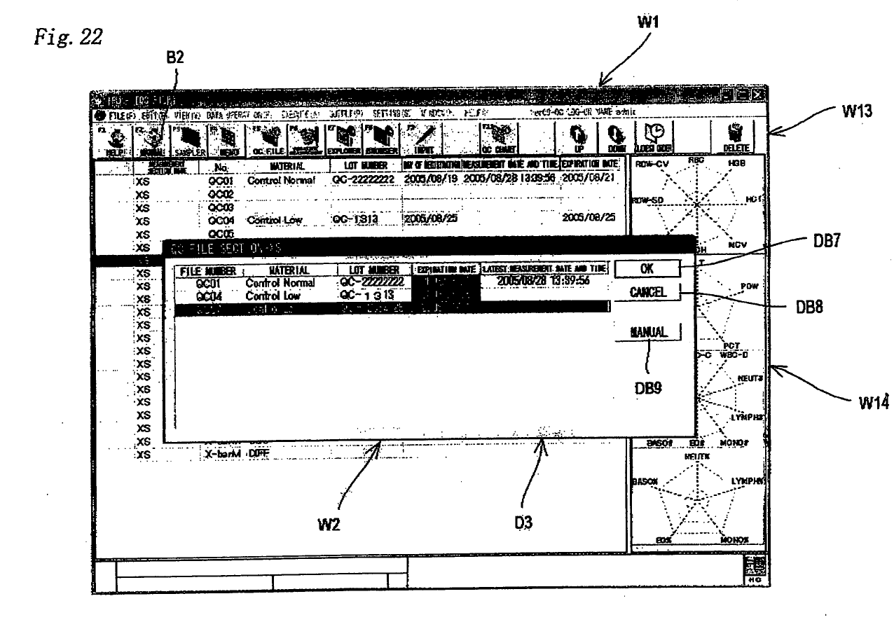

On the other hand, the manual measurement start instruction dialog (quality control substance measurement start instruction screen) D3 for a quality control substance shown in FIG. 22 is displayed when the “Manual measurement” icon B2 is selected while the “QC file” screen (function screen related to the measurement of quality control substance) which displays a quality control substance list is displayed in the view W14.

In this way, the dialog D1 and dialog D2 are associated with the “Manual measurement” icon B2 which is a common third icon and which of the dialog D1 or D2 is displayed varies depending on the function screen displayed in the present view W14.

In such a configuration, the presence of the common icon B2 suffices for the two (plurality of) dialogs D1, D2.

Moreover, since the dialogs D1, D2 are configured so as to give an instruction for starting measurement of a sample or a quality control substance which is selected in the list displayed in the view W14, and therefore it is possible to select a measurement target in the list of the view W14 and give an instruction for starting measurement without changing the display of the view W14 and this makes operation quite easy.

The present invention is not limited to the above described embodiments and can be modified in various ways.

1. A sample analyzer for analyzing a sample, comprising:
a display
first displaying means for displaying a screen on the display, the screen comprising an icon display area and a function screen area, the icon display area having a first area for displaying first and second function-select-icons and a second area for displaying at least one of screen-operate-icon;
second displaying means for displaying the first and second function-select-icons on first area and the screen-operate-icon on the second area;
an input device for receiving input to select at least one of the icons in the icon display area; and
third displaying means for displaying a first function screen on the function screen area and changing the screen-operate-icon which is displayed on the second area, when the input device receives input to select the first function-select-icon,
wherein the screen-operate-icon is assigned to operation of the first function screen.

2. The sample analyzer according to claim 1, wherein the third displaying means displays a second function screen on the function screen area and changes the screen-operate-icon which is displayed on the second area, when the input device receives input to select the second function-select-icon.

3. The sample analyzer according to claim 1, wherein the third displaying means further displays a third function-select-icon on the second area when the input device receives input to select the first function-select-icon.

4. The sample analyzer according to claim 3, wherein the third function-select-icon displayed in the second area by selecting the first function-select-icon is used to display a third function screen related to the first function screen displayed by selecting the first function-select-icon.

5. The sample analyzer according to claim 1, wherein the icon display area is located above the function screen area.

6. The sample analyzer according to claim 5, wherein positions of the icon display area and the function screen area are configured to be changed,

7. The sample analyzer according to claim 1, wherein the first area is arranged on the left side of the icon display area and the second area is arranged on the right side of the icon display area.

8. The sample analyzer according to claim 1, wherein the input device comprises a keyboard which has a plurality of keys, an input operation for a predetermined key of said keyboard is associated with the operation of selecting icons displayed in said icon display area, and
when not selected by the key operation, the icons displayed in said icon display area are displayed as not being selected indicating an unselected state, and when selected by the key operation, the icons are displayed as being selected indicating a selected state.

9. The sample analyzer according to claim 1, wherein the second displaying means displays a dialog icon on the first area, and
the sample analyzer further comprises fourth displaying means for displaying a dialog screen on the display when the input device receives input to select the dialog icon.

10. The sample analyzer according to claim 2, wherein the second displaying means displays a dialog icon on the first area, and
the analyzer further comprises fourth displaying means for displaying a first dialog screen on a dialog screen area when the input device receives input to select the dialog icon while the first function screen displayed by selecting the first function-select-icon, and displaying a second dialog screen on the dialog screen area when the input device receives input to select the dialog icon while the second function screen displayed by selecting the second function-select-icon.

11. The sample analyzer according to claim 10, wherein the first function screen is a screen for measurement of a sample, the second function screen is a screen for measurement of a quality control substance, the first dialog screen is a sample measurement start instruction screen for starting measurement of the sample, and the second dialog screen is an quality control substance measurement start instruction screen for starting measurement of the quality control substance.

12. The sample analyzer according to claim 1, comprising a measurement apparatus for measuring the sample and an analyzing apparatus for analyzing the sample based on the measurement result of the measurement apparatus.

13. A sample analyzer for analyzing a sample, comprising:
a display;
first displaying means for displaying a screen on the display, the screen comprising an icon display area and a function screen area;
second displaying means for displaying a first, a second and a multi function icon on the icon display area, the first icon is assigned to a function of displaying a first operation screen, the second icon is assigned to a function of displaying a second operation screen, and the multi function icon is assigned to operation of the first and the second operation screen;
an input device for receiving input to select at least one of the first icon, the second icon, and the multi function icon; and
third displaying means for displaying the first operation screen on the function screen area when the input device receives input to select the first icon, and displaying the second operation screen on the function screen area when the input device receives input to select the first icon.

14. The sample analyzer of claim 13,
wherein the icon display area and the function screen area are displayed on predetermined positions on the screen; and
the first icon, the second icon, and the multi function icon are displayed on predetermined positions on the icon display area.

15. The sample analyzer according to claim 13, wherein the second displaying means further displays a dialog icon on the icon display area, and
the sample analyzer further comprises fourth displaying means for displaying a dialog screen corresponding to the dialog icon on a dialog screen area which is different from the function screen area, when the input device receives input to select the dialog icon.

16. The sample analyzer according to claim 13, wherein the fourth displaying means displays a first dialog screen on the dialog screen area, when the input device receives input to select the dialog icon while the first function screen displayed by selecting the first icon, and a second dialog screen on the dialog screen area, when the input device receives input to select the dialog icon while the second function screen displayed by selecting the second icon.

17. The sample analyzer according to claim 16, wherein the first function screen is a screen for measurement of a sample, the second function screen is a screen for measurement of a quality control substance, the first dialog screen is a sample measurement start instruction screen for starting measurement of the sample, and the second dialog screen is an quality control substance measurement start instruction screen for starting measurement of the quality control substance.

18. A processing computer for a sample analysis, comprising:
a display
first displaying means for displaying a screen on the display, the screen comprising an icon display area and a function screen area, the icon display area having a first area for displaying first and second function-select-icons and a second area for displaying at least one of screen-operate-icon;
second displaying means for displaying the first and second function-select-icons on first area and the screen-operate-icon on the second area;
an input device for receiving input to select at least one of the icons in the icon display area; and
third displaying means for displaying a first function screen on the function screen area and changing the screen-operate-icon which is displayed on the second area, when the input device receives input to select the first function-select-icon,
wherein the screen-operate-icon is assigned to operation of the first function screen.

19. A method of displaying operation screen for a sample analyzer, comprising:
displaying an operation screen comprising an icon display area and a function screen area, the icon display area having a first area for displaying first and second function-select-icons and a second area;
displaying, when designation of the first function-select-icon is received, a first function screen on the function screen area and a first screen-operate-icon on the second area; and
displaying, when designation of the second function-select-icon is received, a second function screen on the function screen area and a second screen-operate-icon on the second area.

20. A computer program product for a processing computer for a sample analyzer, comprising:
a program code to display an operation screen comprising an icon display area and a function screen area, the icon display area having a first area for displaying first and second function-select-icons and a second area;
a program code to display, when designation of the first function-select-icon is received, a first function screen on the function screen area and a first screen-operate-icon on the second area; and
a program code to display, when designation of the second function-select-icon is received, a second function screen on the function screen area and a second screen-operate-icon on the second area.
